(19) United States
(12) Patent Application Publication
(10) Pub. No.: US 2012/0223943 A1
(43) Pub. Date: Sep. 6, 2012

(54) DISPLAYING DATA FOR A PHYSICAL RETAIL ENVIRONMENT ON A VIRTUAL ILLUSTRATION OF THE PHYSICAL RETAIL ENVIRONMENT

(76) Inventors: Joshua Allen Williams, Cincinnati, OH (US); Mark Alan Peckinpaugh, Liberty Township, OH (US)

(21) Appl. No.: 13/409,524

(22) Filed: Mar. 1, 2012

Related U.S. Application Data
(60) Provisional application No. 61/447,860, filed on Mar. 1, 2011.

(51) Int. Cl. G06T 15/00; G06F 3/041; G09G 5/02; G09G 5/00

(52) U.S. Cl. 345/419; 345/634; 345/173; 345/593

(57) ABSTRACT

Three dimensional models representing retail store elements (gondolas, kiosks, etc.) are identified and tracked for location and orientation on a surface representing a retail store space. Each retail store element is associated with particular retail products or retail product groups. A point of view with respect to the models may be identified and an image of the retail store space and elements displayed on a human-scale display from the identified point of view. As the store elements and/or point of view are changed, the displayed image is updated to provide an immersive experience.

### CROSS REFERENCE TO RELATED APPLICATION

This application claims the benefit of U.S. Provisional Application No. 61/447,860 filed Mar. 1, 2011.

### TECHNICAL FIELD OF THE INVENTION

The present invention relates to methods and devices for displaying data on a virtual illustration.

### BACKGROUND OF THE INVENTION

This Background is intended to provide the basic context of this patent application and it is not intended to describe a specific problem to be solved.

Trying to design a useful layout for a store in order to increase sales or another parameter has been a challenge. Data has been collected but applying the data to a specific store and the layout in the store in a manner that is easy to understand has been a challenge. Short of re-arranging a store, trying to usefully visualize what a store would look like and how sale might occur in the re-arranged store has not been possible, especially in a size and scale that is meaningful to a user.

### SUMMARY OF THE INVENTION

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

A method of displaying sales related data for a physical retail environment that sells physical goods on an electronic illustration of the physical retail environment as a virtual retail environment is disclosed. The method may display the illustration of the virtual retail environment of the physical retail environment on an electronic display in human scale. The illustration may contain a store layout and the store layout may contain virtual store shelves, virtual aisles, virtual departments, a virtual exit, a virtual entrance and a virtual checkout location. Product categories of products for sale in the physical retail environment corresponding to the virtual reality environment may be identified. A unique location may be assigned within the store layout to each of the product. Sales-related data for a plurality of products may be identified. The sales related data for a plurality of products selected by a user may be displayed on the electronic illustration of a virtual retail environment. The data may be displayed in proximity to the location of the corresponding product category within the store layout. Additional detail may be displayed by selecting to see more information about an aisle, a shelf, a category or any other level of detail available.

The virtual store environment may be associated with block models of the virtual store elements, allowing real-time manipulation of the shelves, kiosks, checkouts, walls, etc. Individual tagging of block elements, for example, gondolas and kiosks, allows moving not only the physical elements of the store, but the associated products that are virtually displayed on those shelves.

The physical models may be color coded to correspond to particular product categories. Color coding may be natural in the blocks, or clear blocks may be colored by an underlying surface. The physical models may also include a virtual camera for point-of-view orientation within the block model.

### BRIEF DESCRIPTION OF THE DRAWINGS

FIG. 1 is an illustration of a computing device;

FIG. 2 is an illustration of a method of displaying sales related data for a physical retail environment that sells physical goods on an electronic illustration of the physical retail environment as a virtual retail environment;

FIG. 3 is an illustration of a method of displaying a projection of future sales data based on a revised store layout;

FIG. 4 is an illustration of a sample virtual retail environment;

FIG. 5 is an illustration of a sample virtual retail environment with additional sales detail;

FIG. 6 is an illustration of a sample re-arranged virtual retail environment;

FIG. 7 is an illustration of a sample shelf illustration;

FIG. 8 is an illustration of a sample shelf illustration with additional sales detail;

FIG. 9 is an illustration of additional shelf detail;

FIG. 10 is an illustration of using 3D models in a virtual retail environment;

FIG. 11 is an illustration of an alternate embodiment of using 3D models in a virtual retail environment; and

FIG. 12 is an illustration of a method of using 3D models in virtual retail environment.

### DETAILED DESCRIPTION OF THE INVENTION

Although the following text sets forth a detailed description of numerous different embodiments, it should be understood that the legal scope of the description is defined by the words of the claims set forth at the end of this patent. The detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims.

It should also be understood that, unless a term is expressly defined in this patent using the sentence “As used herein, the term” is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term be limited, by implication or otherwise, to that single meaning. Finally, unless a claim element is defined by reciting the word “means” and a function without the recital of any structure, it is not intended that the scope of any claim element be interpreted based on the application of 35 U.S.C. §112, sixth paragraph.

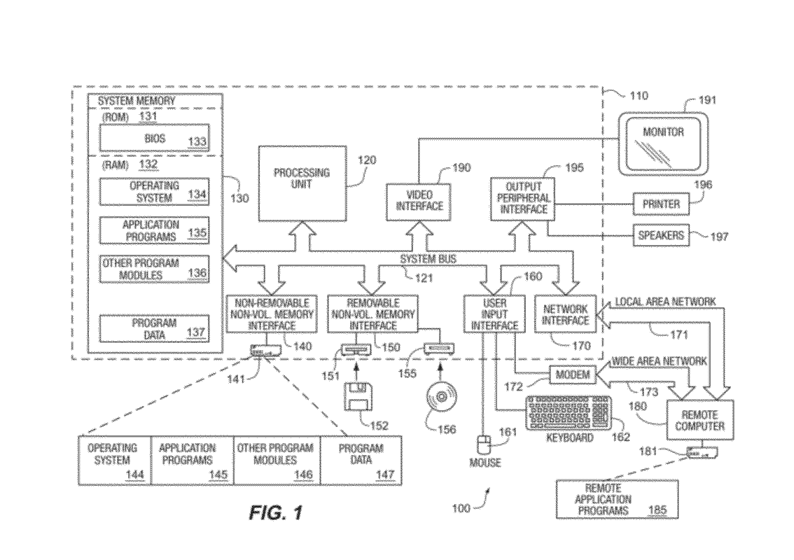

FIG. 1 illustrates an example of a suitable computing system environment 100 that may operate to execute the many embodiments of a method and system described by this specification. It should be noted that the computing system environment 100 is only one example of a suitable computing environment and is not intended to suggest any limitation as to the scope of use or functionality of the method and apparatus of the claims. Neither should the computing environment 100 be interpreted as having any dependency or requirement relating to any one component or combination of components illustrated in the exemplary operating environment 100.

With reference to FIG. 1, an exemplary system for implementing the blocks of the claimed method and apparatus includes a general purpose computing device in the form of a computer 110. Components of computer 110 may include, but are not limited to, a processing unit 120, a system memory 130, and a system bus 121 that couples various system components including the system memory to the processing unit 120.

The computer 110 may operate in a networked environment using logical connections to one or more remote computers, such as a remote computer 180, via a local area network (LAN) 171 and/or a wide area network (WAN) 173 via a modem 172 or other network interface 170.

Computer 110 typically includes a variety of computer readable media that may be any available media that may be accessed by computer 110 and includes both volatile and nonvolatile media, removable and non-removable media. The system memory 130 includes computer storage media in the form of volatile and/or nonvolatile memory such as read only memory (ROM) 131 and random access memory (RAM) 132. The ROM may include a basic input/output system 133 (BIOS). RAM 132 typically contains data and/or program modules that include operating system 134, application programs 135, other program modules 136, and program data 137. The computer 110 may also include other physical removable/non-removable, volatile/nonvolatile computer storage media such as a hard disk drive 141 a magnetic disk drive 151 that reads from or writes to a magnetic disk 152, and an optical disk drive 155 that reads from or writes to an optical disk 156. The hard disk drive 141, 151, and 155 may interface with system bus 121 via interfaces 140, 150. Communication media, separate from the computer readable media and computer storage media described above, may include data signals and propagated media such as carrier waves.

A user may enter commands and information into the computer 110 through input devices such as a keyboard 162 and pointing device 161, commonly referred to as a mouse, trackball or touch pad. Other input devices (not illustrated) may include a microphone, joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device may also be connected to the system bus 121 via an interface, such as a video interface 190. In addition to the monitor, computers may also include other peripheral output devices such as speakers 197 and printer 196, which may be connected through an output peripheral interface 195.

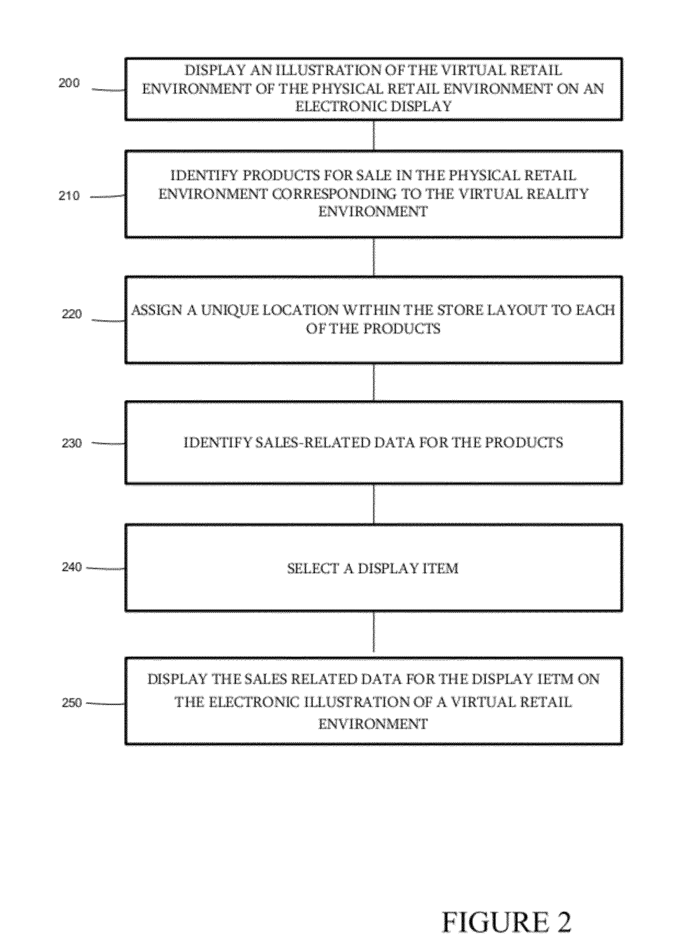

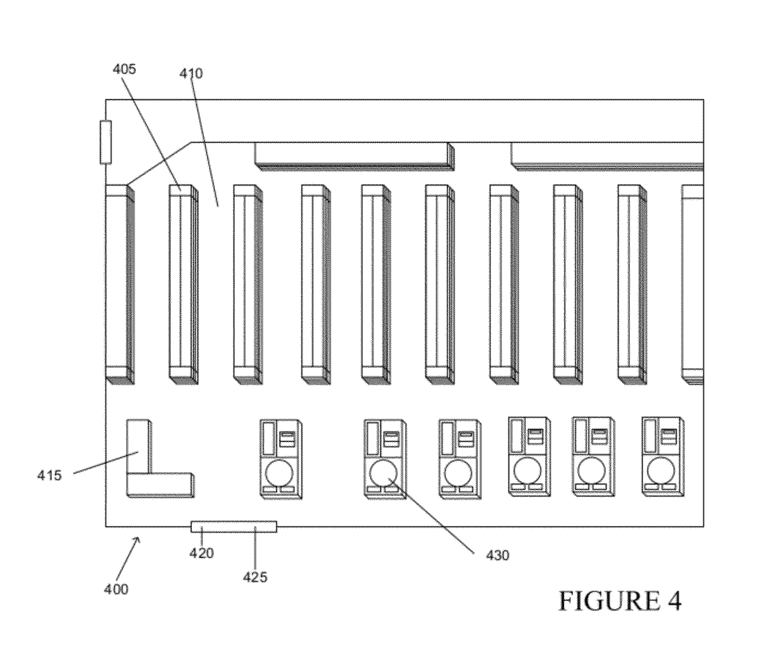

FIG. 2 illustrates a method of displaying sales related data for a physical retail environment that sells physical goods on an electronic illustration of the physical retail environment as a virtual retail environment. Attempting to visualize sales from a physical location in a store is difficult. It would be useful to have a way to more easily understand and visualize where sales and profits, for example, are coming from in a physical store can be difficult. Further, it would be useful to see how changes to a physical store environment might look without actually changing the physical environment. At the same time, it would be useful to see how current sales might be affected by a rearrangement of the physical store. FIG. 4 is a sample illustration of a virtual store.

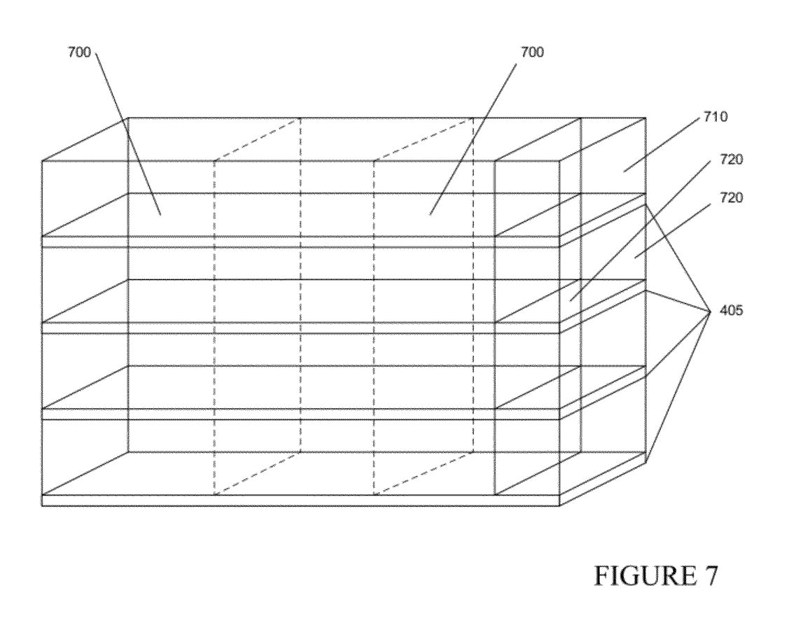

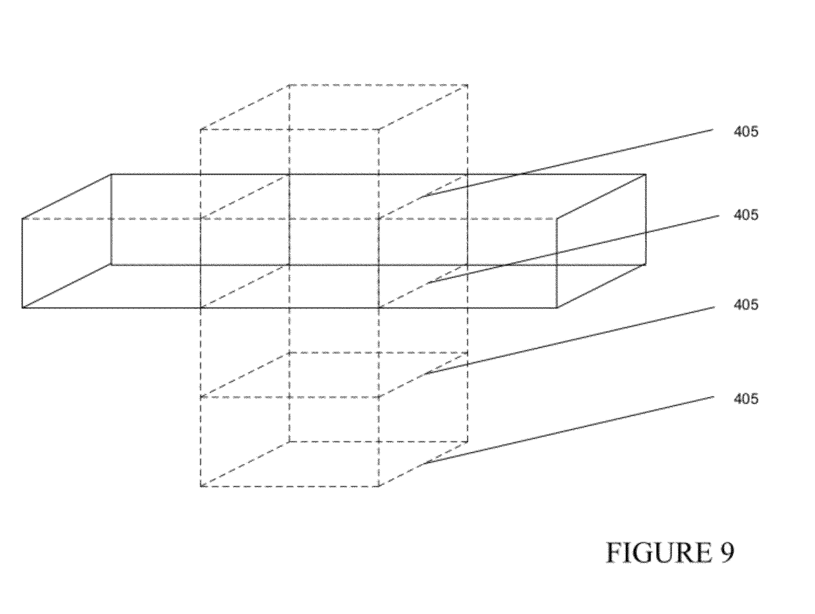

At block 200, an illustration of the virtual retail environment 400 of the physical retail environment may be displayed on an electronic display 191. FIG. 4 may be a sample illustration. The illustration 400 may include a store layout that includes by example and not limitation virtual store shelves 405, virtual aisles 410, virtual departments 415, a virtual exit 420, a virtual entrance 425, and virtual checkout locations 430. The illustration 400 may be in three dimensions and may be very graphically similar to the actual store or the illustration 400 may be a simple sketch. For example, FIG. 4 may display a store layout 400 while FIG. 7 may display a section of an aisle 410 and the individual shelves 405 on the section. FIG. 9 may be even more specific reflecting the specific placement of goods on the shelves 405. The physical retail environment may be any well known or future designed physical retail environments. The examples of physical retail environments are virtually limitless, from supermarkets to electronics stores to drug stores.

Similarly, the physical goods in the physical store may be a virtually limitless list. The physical goods likely will vary by store. The list of goods may be obtained from the specific store, from a corporate parent or from publicly available information. In addition, the goods may be brand specific or may cover a variety of brands.

The electronic display 191 may be a single traditional monitor, a plurality of monitors or a projection as long as the monitors and or projections are sufficient to display the illustration 400 on a human scale. As the price of monitors drop and size increases, and the projection technologies improves, displaying products at a human scale is possible and practical. In addition, graphics and the ability to manipulate graphics has made it possible to render extremely life-like versions of products 700 at a human scale. By human scale, the products are displayed in a size and a clarity that mimics the size and scale that would be seen in a store. The monitors or display surfaces 191 may be arranged in a surrounding manner such that a user can maneuver (step, turn around, reach, etc.) and feel as if they are in a store. For example, the displays 191 may be in a curve and a user may be able to feel as if they are walking through an aisle and can see items on shelves on each side of them and in front of them. The items may be of a scale and clarity as if they were in a store. In some embodiments, the display may be in three dimensions by using traditional three dimension techniques and three dimension glasses.

By displaying the items in a human scale, additional insights may be made. For example, the advantage of using a consistent color on products by the same supplier may be impossible to see on a traditional computer monitor. However, when seen in human scale, the ability to quickly identify and locate products from a particular supplier may be seen. In addition, by using such a large scale, data may be displayed in a manner that simply is not possible on a traditional computer monitor. For example, as the displays are so much larger than a traditional monitor, much more data may be displayed in a useful and readable form. More specifically, displaying sales data for all products 700 in the dishwasher soap category 710 may be impossible on a traditional computer monitor, but by using such a large scale, a vast amount of sale data may be across the human scale display 191.

As another example, the effect of moving a product 700 from a first shelf to a second shelf may not be fully appreciated on a typical computer monitor. But using the human scale, the effect of moving a product 700 from knee level to eye level may be striking. In addition, the product category 710, for example, may take on more meaning as competing products 700 may be seen in their true size, rather than as dots on a typical computer monitor.

At block 210, products 700 for sale in the physical retail environment may be identified corresponding to the virtual reality environment in the illustration 400. As stated previously, the products 700 for sale in the retail environment may be obtained in a variety of ways. In one example, the products for sale may be obtained from the retailer. In other embodiments the products 700 for sale are obtained from a parent or from competitive intelligence. In other embodiments, the products 700 for sale may be products that the retailer could sell but currently does not.

The products 700 may be broken down into categories 710 and the categories 710 may include product sub-categories 720. Categories 710 may be any categories 710 that are relevant to the analysis. FIG. 7 illustrates shelves 405 being separated and having categories 710, such as soap and snacks. For example, the category of snacks 710 could include pretzels and potato chips as sub-categories 720. The categories 710 may be further broken down into sub-categories 720 for specific audiences, such as name brand audiences, bargain audiences, etc. For example, name brand audiences may be interested in heavily advertised shampoo while bargain shoppers may only look for shampoos that have a price below a certain point. Of course, other sub-categories 720 are possible and are contemplated.

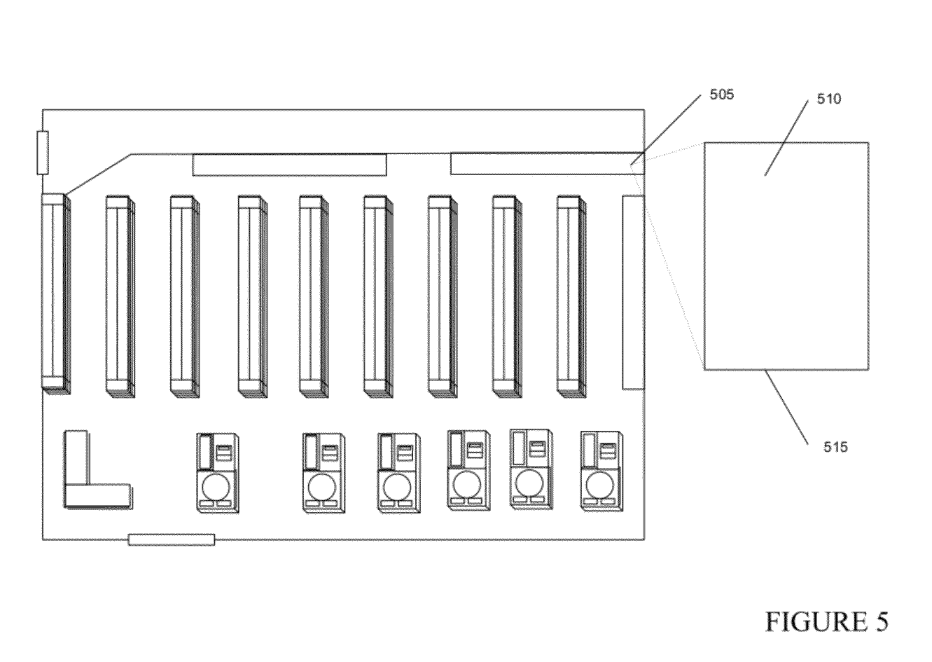

At block 220, a unique location 505 (FIG. 5) within the store layout 405 may be assigned to each of the products 700. The location 505 may be specific as a specific shelf in a specific aisle at a specific height or may be less specific, depending on the desires of the user. The unique location 505 may be adjusted, either automatically or by the user, in an attempt to maximize sales, minimize costs, maximize profits, etc.

At block 230, sales-related data 510 for a plurality of products 710 may be identified. The sales related data 510 may be the gross sales on a normalized basis or profit margin or any other relevant sales data for the products 700. Sales data 510 may also include sales data 510 for a virtual shopper category, sales data 510 for similar retailers in the same region, projected sales data 510 and sales data 510 collected using loyalty cards. For example, sales data 510 related to specific types of shampoo may be identified. The sales data 510 may be provided by the store itself, or may be provided by a parent organization or from other publicly available sources.

At block 240, a display item may be selected. The display item may be the product 700 a product category 720, the virtual store shelf 405, the virtual aisles 410 and the virtual departments 415. Of course, a combination of these items also may be selected as the display is large enough to display vast amounts of data in a meaningful way.

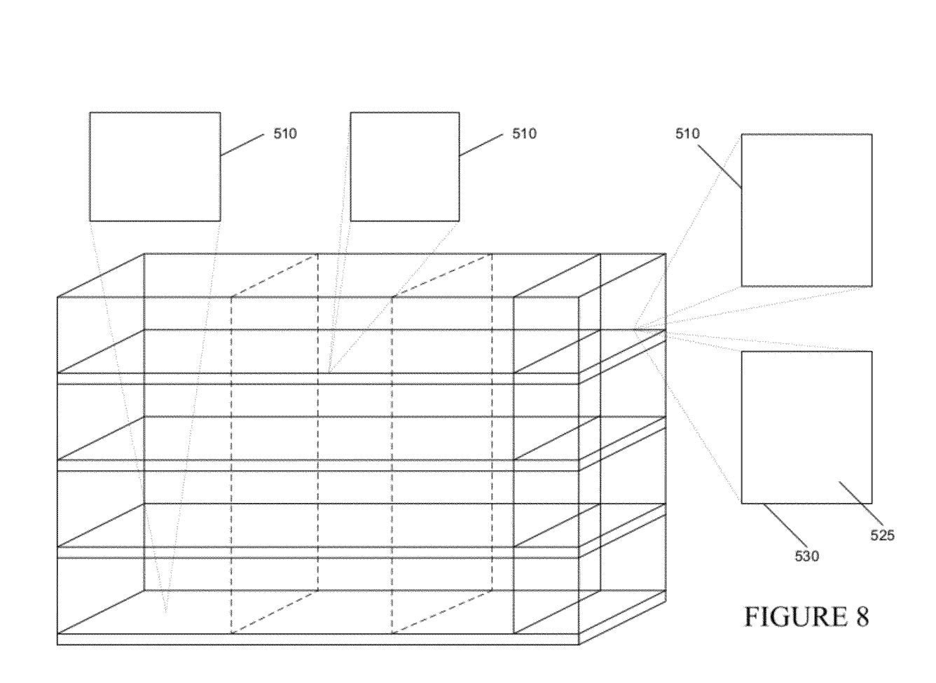

At block 250, the sales related data 510 for a plurality of products 700 may be displayed on the electronic illustration 400 of a virtual retail environment wherein the data for each product 700 is displayed in proximity to the location 505 of the corresponding product 700 within the store layout. FIG. 5 may be an illustration of sales data 510 being displayed on the illustration of the virtual environment 400. The data 510 may be displayed in a separate window 515 or may be displayed on entirely separate monitor 191. FIG. 8 may be an illustration where specific sales data 510 for a shelf 405 on an aisle 410 are displayed.

The sales related data 510 may be displayed automatically or may be selected by a user. The selection may occur in many logical manners. In some embodiments, simply rolling over a shelf 405, aisle 410 or department 415 may start the display of sales related data 510. In another embodiment, the shelf 405, aisle 410 or department 415 must be selected such as by clicking a mouse or tapping a display 191. In some embodiments, the areas that may be selected may be highlighted or indicated in any other reasonable manner. Of course, other embodiments are possible and are contemplated.

The type of sales data 510 may have a default value or may be selected by a user. For example, a default value may be to display total sales for a category 700 and a user may be able to select to see profit data, growth data, etc. In addition, a user may be able to create a specific query and the sales data 510 may be retrieved and displayed on the virtual illustration 400. The query may be made using a separate display or may be retrieved from another application. By way of example and not limitation, the sales data 510 may also include customer traffic data where customer traffic data may include how many people pass the location and how long customers stay in an area, etc.

The electronic illustration 400 may be adjusted to display sales data only about specific products 700 or categories 710. For example, sales data 400 may first be displayed for shampoo and then sales data 510 may be displayed for toothpaste. In addition, the sales data 510 may be further refine by customer type such as name brand shoppers, bargain shoppers, etc. Further, the display 400 may be adjusted for sale profit, sales volume or sales growth. For example, items that have a sales profit of at least 20% may be displayed, then items that have a sales profit less than 20% but greater than 15% may be displayed. In yet another embodiment, each of the different groups may be displayed using a different color to further differentiate between categories 710, sub-categories 720, etc. The data may be overlaid on the electronic illustration of the virtual retail environment 400 and each of the different colors may be selected to display more specific information about the group selected.

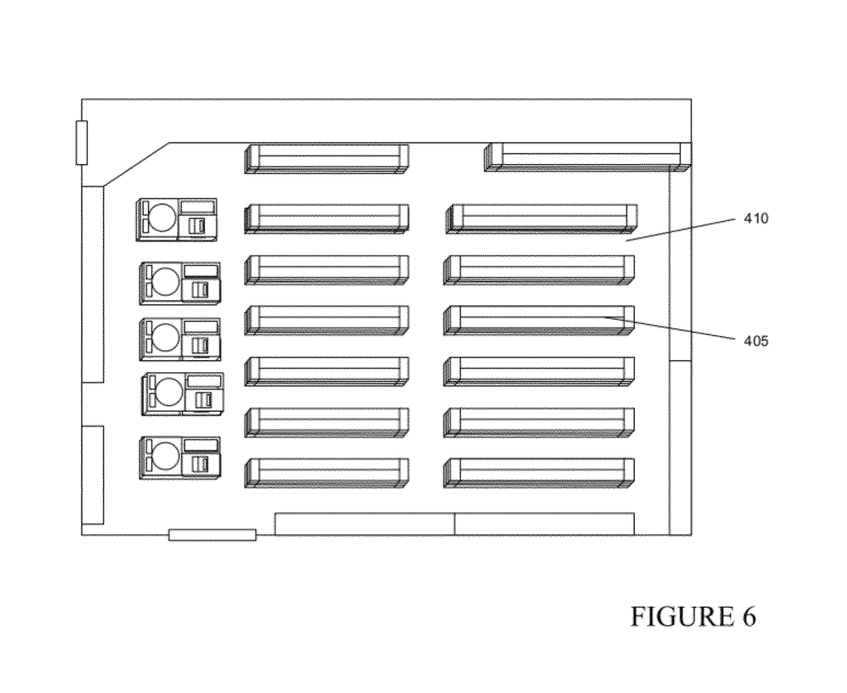

In some embodiments, the store layout may be re-arranged to illustrate different locations for the product categories 700 in different store layouts. FIG. 6 is one illustration where the same footprint of a physical store in FIGS. 4 and 5 is reconfigured. Similar to FIG. 5, additional sales data 510 may be displayed over the new store layout. The sales data 510 may be actual data or projected sales data. The display may include a before and after illustration that shows sales using the current configuration and sales in an after configuration.

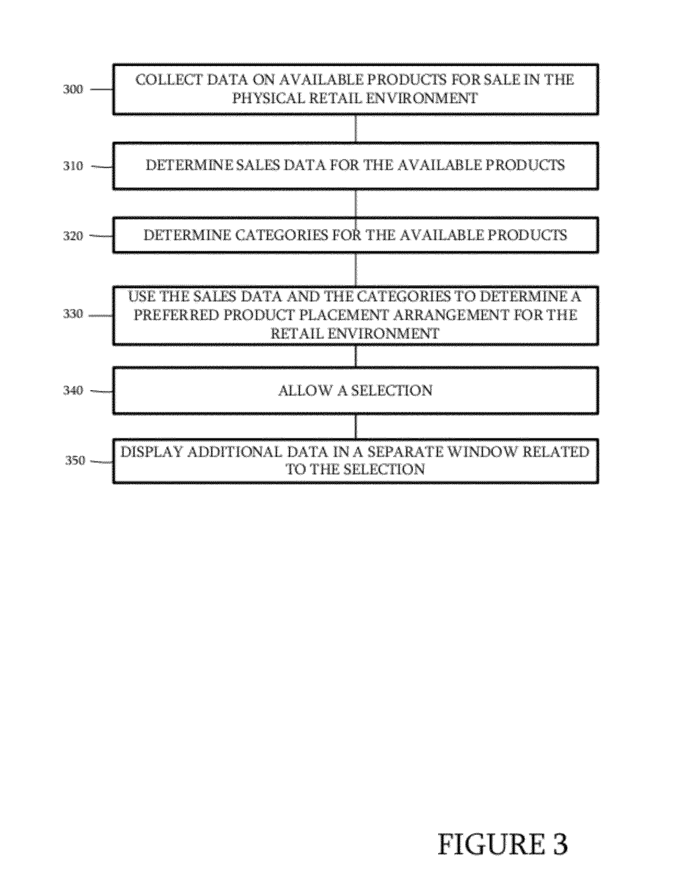

The display may also project sales data 510 that may occur if the arrangement of the store layout is adjusted. FIG. 3 may illustrate one possible method for displaying a projection of future sales data based on a revised store layout. At block 300, data may be collected on available products for sale in the physical retail environment. This data may be the same data as used in FIG. 2. The data may be sales data 510 from the specific store, may be proprietary data or may be based on publicly available data. Available products 700 may also include products 700 that logically could be sold in the physical location but currently are not.

At block 310, sales data 510 may be determined for the available products 700. As available products 700 may include products 700 that are currently not for sale, projections may be made of future sales. The projections may be made in a variety of ways. For example, the projections may be made using similar stores in the area or using stores with similar demographic data. Any logical manner of projecting sales would be sufficient.

At block 320, categories 710 may be determined for the available products 700. Again, the categories 710 could be a wide range of classifications. For example, the products 700 could be split at a high level such as products 700 for inside the home and products 700 for outside the home. Other classifications may be more specific such as brands of shampoo. Again, the brands may also be separated by the categories 710 of buyer such as name brand buyers, bargain buyers, etc

At block 330, the sales data 510 and the categories 710 may be used to determine a preferred product 700 placement arrangement for the retail environment by placing available products on virtual shelves in virtual departments in the virtual retail environment 400. The determination of the preferred product placement may be determined in a variety of ways using a variety of algorithms, all of which may be selected and modified by a user. In one embodiment, assigning a preferred location 505 may entail determining traffic patterns in the store, determining layout and adjacency parameters and using an algorithm to maximize a parameter. Sample parameters may include sales volume, sales margin and sales growth. The preferred location 505 also may be shopper-type specific.

At block 340, a selection may occur. The selection may be an available product 700, virtual shelf or virtual department or any other relevant aggregation. At block 350, additional data 525 may be displayed in a separate window 530 related to the selection. Additional data may include sales growth, sales decline, sale margin and sales gross. Other additional data are possible and are contemplated.

Color or other visual aides may also be used to indicate a variety of useful information. In one embodiment, the selection from block 340 may be highlighted using a separate color shade. In another embodiment, color may be used to highlight areas of interest to different consumers, such as highlighting products for value shoppers in red and products for name brand shoppers in blue. Of course, other visual aides to draw the attention of a user such as causing displayed elements to flash, to be outlined, to have shadows, etc.

The store layout may be toggled between a first store layout (FIG. 4) and a second store layout (FIG. 6). In this way, proposed changes to the physical layout may be imagined and the resulting change in sales may also be projected. In some embodiments, the first layout may be in a first color and the second layout may be in a second color and the layouts may be displayed over each other. Of course, other manners of toggling between the first and second layouts are possible.

In modeling a store or other retail setting, 3D shapes representing store elements such as gondolas, wall shelving, kiosks, checkout stands, etc., can be used to create a miniature version of the store. An advantage of the physical model is that the relationships between store elements is easily comprehended and changes can be implemented with a simple move of the hand. However, the 3D model does not allow accurate portrayal of merchandise, color effects, sightlines, and, as described above, related sales data, to be included. A virtual model allows viewing details of products and a perspective view of a consumer but lacks the overall view of the layout and may be cumbersome to make changes to individual store elements. By combining the advantages of a 3D physical model in terms of ease of arrangement and comprehension of the overall store layout with the detail and point of view of the virtual model, a user is given the ability to make layout changes in context of the overall store and see in real time a visual view of the store with product-level detail.

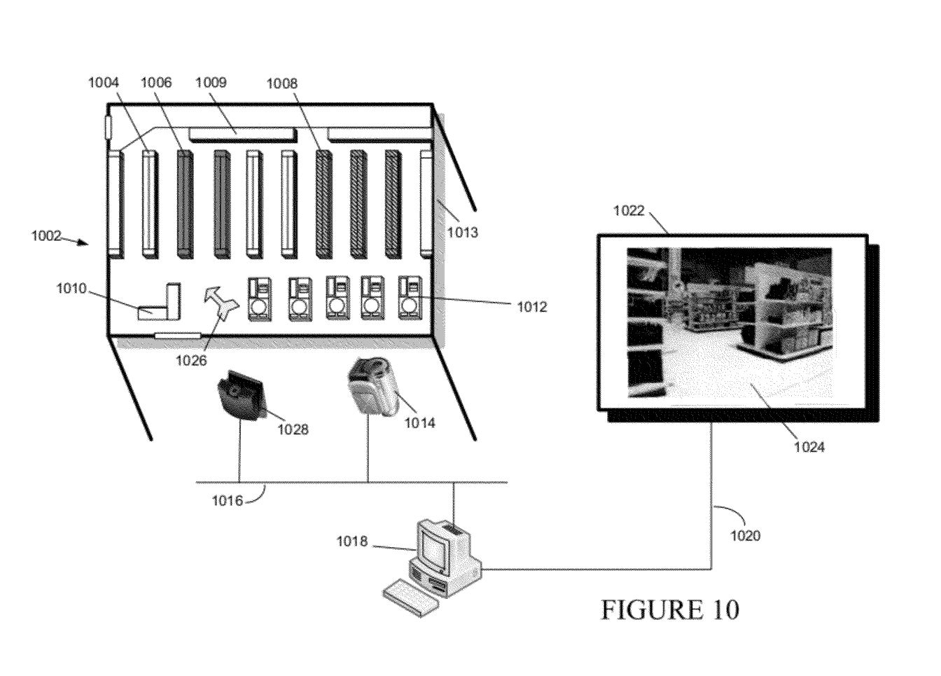

FIG. 10 illustrates the use of three dimensional (3D) models in a virtual retail environment. A model retail store environment 1002 can include representative model retail store elements 1004-1012, including gondolas 1004, 1006, 1008, for example, from different product families, wall shelving 1009, a kiosk 1010, and checkout stands 1012. Each model retail store element may represent a respective single physical retail environment element in a retail store space. A table surface 1013 may provide the base for the model 1002 and may include a sensor, such as a camera 1014.

When the camera 1014 is used as the sensor, the table surface 1013 may be transparent or translucent and the bottom of each store element 1004-1012, as well as other items, such as a pointer 1026, may have distinctive markings allowing identification of the element as well as its location and orientation. Such an exemplary table surface and optical system is available from Kommerz Di Kienzl Keg, Annenstrasse 57a, A-8020 Graz, Austria.

The camera 1014 may be coupled to a computer 1018 via a network 1016. The computer 1018 may also be connected via the same network 1016 or a different network 1020 to a human scale display 1022.

In operation, each model element 1004-1012 may be associated with particular product images or other graphic images such as signage and color schemes so that the computer 1018 can render an accurate representation of each model element 1004-1012 as would be seen in a real store.

A pointer 1026 may be used to establish a point of view. For example, a physical 3D model of the pointer 1026 shown in FIG. 10 may be used. Alternatively, a virtual pointer may also be identified electronically on the computer 1018. A sightline for the field of view of the virtual store from the perspective of the pointer 1026 may be calculated. The field of view may include not only gondolas and shelves with rendered product images, but walls, graphics, windows, etc.

The computer 1018 can then generate or render an image 1024 of the virtual retail environment on the human scale display 1022 from the identified point of view. The use of a human scale display 1022 allows evaluators and test subjects to interact as much as possible with the virtual retail environment. The use of additional human scale displays (not depicted) arranged to match aisles and/or walls would provide a more complete immersion experience.

When changes are desired, a particular model element 1004-1012 may be moved and the movement detected by the camera 1014, or other sensor. The corresponding changes may be reflected on the human scale display 1022.

To assist in identifying the nature of the 3D model elements 1004-1012, each may be color coded by general type, e.g. snacks, cosmetics, etc. Alternatively, the blocks may be translucent and their color assigned by the computer 1018. In this embodiment, a projector 1028 may then provide the appropriate backlight to color the individual model elements 1004-1012. As the blocks move, the projection would be updated to follow the movement and maintain the assigned color coding.

As discussed above, to better evaluate the presentation of product items on particular shelves or at particular locations, sales data for the displayed products or categories may be overlaid on the virtual retail environment in proximity to those products or categories.

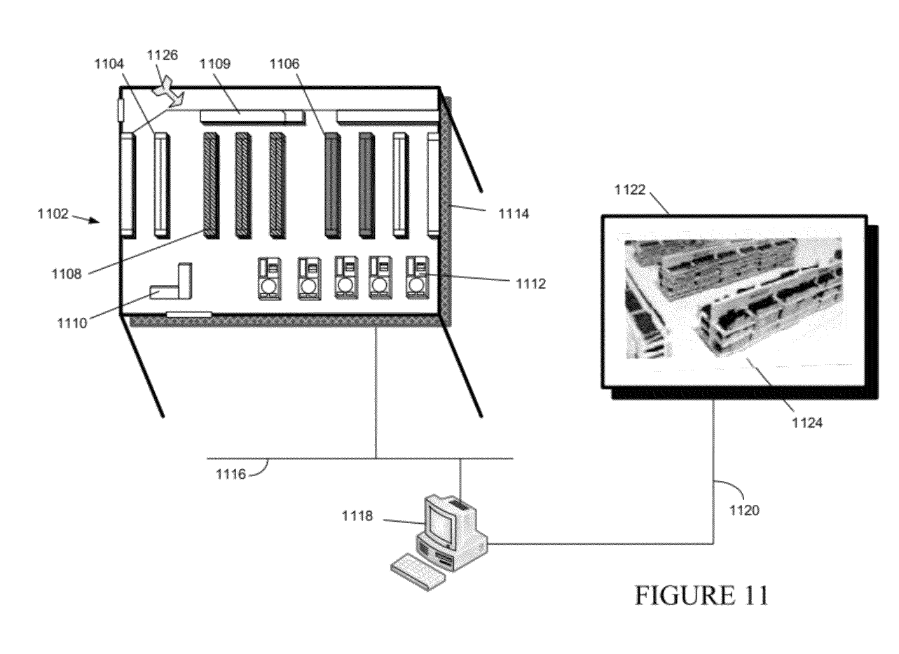

FIG. 11 illustrates another embodiment of the use of three dimensional (3D) models in a virtual retail environment. A model retail store environment 1102 can also include, as depicted in FIG. 10, representative model elements 1104-1112, including gondolas 1104, 1106, 1108, for example, from different product families, wall shelving 1109, a kiosk 1110, and checkout stands 1112.

A table 1114 may have an active surface with both an integrated display and integrated sensors. An exemplary table may be the Microsoft Surface® available from Microsoft® of Redmond, Wash. In such an embodiment, the 3D models may have different identifiers for sensing by the table 1114, such as capacitive components or radio frequency identifier (RFID) tags.

The table 1114 may be connected to a computer 1118 via network 1116. The computer 1118 may also be connected to a human scale display 1122 that is used to display an image of the virtual retail environment 1124 from a particular point of view, as discussed above. In this embodiment, the pointer 1126 may be a wireless mouse with motion sensing to allow the point of view to be anywhere in the 3D space above the table 1114, not just at an ‘eye level’ view.

As above, changes in the layout of the 3D models or in the point of view indicated by the pointer 1126 may be immediately reflected in the display of the virtual retail environment.

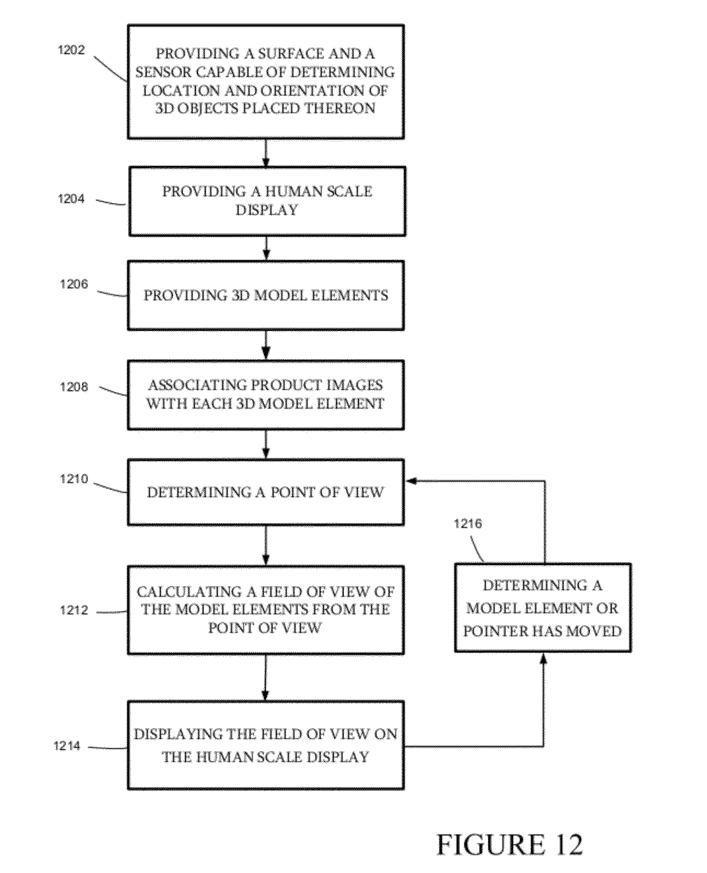

FIG. 12 is an illustration of a method of using 3D models in virtual retail environment.

At block 1202, a surface may be provided. The table surface may have a sensor capable of determining the location and orientation of items placed on the table. To accomplish this, the items may have tags that uniquely identify those items. For example, a camera 1014 may be used as the sensor and the tags may be visible indicators that can be seen through the surface. In another embodiment the surface may be a touch sensitive screen and the tags may be electrical or physical components that can be identified by the touch sensitive screen.

At block 1204, one or more human scale displays may be provided, such as display 1022. When more than one human scale display is used, they may be arranged to simulate parts of a retail environment, such as both sides of a gondola, facing sides of two gondolas, one side of a gondola and a perpendicular wall, etc.

At block 1206, a number of three dimensional (3D) model elements may be moveably placed on the surface, the model elements having a three dimensional shape having a tag identifiable by the sensor for establishing a location and an orientation of the model elements. The model elements may include retail and non-retail model elements. Non-retail model elements may include walls or lavatory facilities. Retail model elements may represent a respective one physical retail environment element including but not limited to, a store gondola with shelving, a wall with shelving, a department, a kiosk, or a checkout location. In some cases, each of the retail model elements, and optionally all model elements, may be color coded according to the product type of its respective physical retail environment counterpart. For example, all retail model elements associated with consumable items may be green, and all cosmetic and health care retail model elements may be red and violet, respectively. In one embodiment, the model elements are simply made in that color (e.g. painted). In another embodiment, the model elements may be a transparent or translucent glass or plastic and may be colored by a projector 1028 or backlight by the surface.

At block 1208 each model element may be associated with an image of its real-world counterpart. In particular, retail model elements may be associated with images of the actual products found in its real-world counterpart. The images may be collective, that is, a gondola of food items may have a single image of a representative gondola or a single shelf of the gondola. In another embodiment, individual images of each product may be associated with a retail model element and individually rendered onto the shelves at the time they are displayed. Other combinations of image matching may be incorporated. Images of other store features, such as walls, banners, windows, etc. may also be captured and used in rendering the virtual retail environment.

At block 1210, a point of view may be determined for use in rendering a perspective of the retail environment. In some cases the point of view may be selected at a control computer with simple mouse movements. In another embodiment, a pointer, such as model element 1026 may be placed on the surface as a tactile and visual placeholder of the point of view to be displayed. In this embodiment, the model element 1026 may have a tag similar to the other model elements for determining location and orientation. The height of the point of view may be fixed at eye level or may be adjustable through a secondary operation. In yet another embodiment, a spatially-sensitive pointer may be used, such as is found in a Wii® Game System, allowing the point of view to be creating anywhere above the surface, whether at eye level or some other height. Other point of view recognition methods may be contemplated, including, but not limited to, hand gesture sensing.

At block 1212, a field of view may be calculated using the location and orientation of the point of view to render a perspective view of the retail model elements and their associated product images.

At block 1214, the calculated field of view may be displayed on the human scale electronic display, to provide a perspective view of the virtual store showing the physical elements of gondolas, kiosks, walls, shelves, etc., and the products associated with each of the those physical elements integrated together. Optionally, as described above, sales information associated with those products may be displayed. In one embodiment, sales data may be shown proximate to the images of the retail items.

At block 1216, when either a model element is moved or the point of view is moved, for example, by moving the pointer 1026, operations from block 1210 may be repeated to calculate a new point of view and a new field of view showing the changes in either model element placement, point of view, or both. In some cases, only the currently display model elements may be involved, requiring only a change in perspective. In other cases, model elements not currently visible may be involved so that the newly detected model element would need to be incorporated into the field of view. In other cases, the model element being moved may not be in the field of view, so even though a virtual map of store elements maintained in the computer memory may be updated, no changes to the displayed images would be necessary.

It is contemplated that sufficient processing power would be available to update and render the images in real time or near real time so that a user could take a virtual walk through the store. This integration of 3D models, retail product images, sales data, and human scale displays provides both architects and marketing professionals a beneficial way to quickly and efficiently evaluate store designs and layout changes, with the goal of providing consumers with a better shopping experience.

In conclusion, the dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention.

Further, to the extent that any meaning or definition of a term in this document conflicts with any meaning or definition of the same term in a document incorporated by reference, the meaning or definition assigned to that term in this document shall govern. The detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims. While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A method of presenting an electronic illustration of a retail environment comprising:
providing a table surface with a sensor;
providing model elements moveably placed on the table surface, the model elements including a plurality of retail model elements, each model element a three dimensional shape having a tag identifiable by the sensor for establishing a location and an orientation of each of the model elements on the table surface, each retail model element representing a respective one physical retail environment element selected from a set comprising a store gondola with shelving, a wall with shelving, a department, or a checkout location;
associating at least one of a product image and a graphics image with each retail model element, the product and graphic images illustrating products for sale, store signage or color schemes.
providing an electronic display in human scale that creates a partially surrounded space;
determining a point of view with respect to each of the plurality of retail model elements;
calculating a field of view showing the retail model elements and the product and graphic images associated with the retail model elements viewable from the point of view; and
displaying the field of view on the electronic display.

2. The method of claim 1, further comprising:
determining one of the plurality of retail model elements has moved;
determining that the one of the plurality of retail model elements is in the field of view; and
redisplaying the field of view to illustrate an updated location of the one of the plurality of retail model elements.

3. The method of claim 1, further comprising providing a pointer, wherein the point of view is established by determining a location and orientation of the pointer.

4. The method of claim 3, further comprising:
determining that the pointer has moved; and
redisplaying the field of view to correspond to a new location of the pointer.

5. The method of claim 4, wherein determining the location and orientation of the pointer comprises interpreting a touch-sensitive input device or gesture sensitive input device.

6. The method of claim 1, further comprising illuminating each of the plurality of retail model elements with colors projected from the table surface, wherein a projected color of each retail model element is assigned according to its respective physical retail environment element.

7. The method of claim 1, wherein providing the model elements comprises providing each of the plurality of retail model elements in colors wherein a color of each retail model element is representative of the retail model element's respective physical retail environment element.

8. The method of claim 1, further comprising:
identifying products for sale in the retail environment corresponding to the displayed field of view;
identifying sales-related data for the products for sale;
displaying the sales-related data on the electronic illustration of the retail environment wherein the sales-related data is displayed in proximity to a corresponding product for sale.

9. A system for developing and displaying a virtual model of a retail store space comprising:
an electronic display system in human scale;
a plurality of three dimensional (3D) objects, each of the plurality of 3D objects representing a retail store element, the retail store elements including a gondola with shelving, a wall display with shelving, a department, a kiosk, and a checkout station;
a surface supporting the (3D) objects, the surface integrated with a sensor that reports a location and an orientation of each of the 3D objects placed on the surface;
a memory storing:
product images and background images corresponding to retail products, the product images including representations of the retail products displayed on representative retail store elements;
a unique identifier for each 3D object;
a mapping between each 3D object and a respective retail store element; and
a computer coupled to the surface, the memory, and the electronic display system wherein the computer receives the location and orientation of each of the plurality of 3D objects on the surface, determines a point of view into the virtual model of the retail space, renders virtual objects for each 3D model element visible from the point of view, renders corresponding product images onto the virtual objects according to the mapping, and presents resulting rendered virtual objects with the product images on the electronic display system in human scale from the determined point of view.

10. The system of claim 9, wherein the electronic display system comprises a first display in human scale and a second display in human scale, the first and second displays oriented at an angle with each other corresponding to physical elements in the retail store space.

11. The system of claim 9, wherein the 3D objects are color coded by a product type.

12. The system of claim 9, wherein the surface includes a color output and the 3D objects are colored by the surface according to a product type.

13. The system of claim 12, wherein movement of the 3D objects on the surface results in adjustments to the color output to maintain a consistent color for each 3D object according to each respective product type.

14. The system of claim 9, wherein the memory further stores retail space sightlines and the computer includes renderings of the retail space sightlines when displaying the rendered virtual objects on the electronic display system.

15. The system of claim 9, wherein the memory further stores sales-related data for the retail products and the computer presents the sales-related data for the retail products visible on the electronic display system.

16. A computer-readable storage media storing instructions executed on a computer to implement a method of modeling a retail store space, the method comprising:
receiving, from a sensor, an identifier of a model and a location and orientation of the model relative to a defined space;
using the identifier, associating a retail store element with the model;
merging an image of the retail store element into an image of the retail store space at a location and orientation corresponding to the location and orientation of the model; and
projecting the merged images onto a human scale display.

17. The computer-readable storage media of claim 16, wherein projecting the merged images comprises:
receiving real-time indications of a moving point of view; and
updating and projecting the merged images in real time from a perspective of the moving point of view.

18. The computer-readable storage media of claim 16, further comprising:
projecting a color associated with the retail store element onto the model.

19. The computer-readable storage media of claim 16, further comprising:
receiving data from the sensor, the data associated with movement of the model with respect to the defined space; and
updating the merged images to incorporate the movement of the model; and
projecting the updated merged images onto the human scale display.

20. The computer-readable storage media of claim 16, further comprising:
associating product images with the retail store element, wherein merging the image of the retail store element into the image of the retail store space includes merging product images into the retail store element.
